(19) United States
(12) Patent Application Publication
(10) Pub. No.: US 2011/0183118 A1
(43) Pub. Date: Jul. 28, 2011

(54) GLASS FRIT COATINGS FOR IMPACT RESISTANCE

(76) Inventors: Lisa Ann Lamberson, Painted Post, NY (US); Robert Michael Morena, Lindley, NY (US)

(21) Appl. No.: 12/979,442

(22) Filed: Dec. 28, 2010

Related U.S. Application Data
(60) Provisional application No. 61/299,168, filed on Jan. 28, 2010.

(51) Int. Cl. B32B 3/08; B32B 3/02; C03C 21/00; C03C 17/04; C03C 8/10; C03C 8/08; C03C 8/02

(52) U.S. Cl. 428/157; 428/192; 428/188; 65/60.1; 65/30.14; 501/22; 501/24; 501/21

(57) ABSTRACT

A glass article having improved edge strength. The glass article includes a glass substrate and an outer edge comprising a glass frit disposed on the edge of the substrate, wherein the glass frit is under compression. Methods of making the glass article and strengthening the edge of a glass article are also provided.

### CROSS REFERENCE TO RELATED APPLICATIONS

This application claims the benefit of U.S. Provisional Application No. 61/299,168, filed Jan. 28, 2010.

### BACKGROUND

Glass is being designed into electronic devices for use as cover glass, display screens and touch panels. Such devices include, but are not limited to, telephones and other communication devices; entertainment devices, such as games, music players, and the like; and information terminal (IT) devices, such as laptop computers.

Glass is typically used as a cover glass or substrate in applications in which a bezel protects the edge of the glass from damage during use during the lifetime of the product. The use of such glass covers in which the edge of the glass is free or “proud” of the bezel requires that the edge of the glass be unprotected or exposed. Additional strengthening of the exposed edge is needed for such unprotected applications.

Edge coating of glass substrates with polymeric materials has been demonstrated to be useful to reduce the “brittleness” and increase strength for window glass. However, many such coatings tend to degrade at temperatures above 200° C. due to the presence of organic components, and thus preclude subsequent strengthening of the glass substrate by either thermal or chemical means.

### SUMMARY

A glass article having improved edge strength is provided. The glass article includes a glass substrate and an outer edge comprising a glass frit disposed on the edge of the substrate, wherein the glass frit is under compression. Methods of making the glass article and strengthening the edge of a glass article are also provided.

Accordingly, one aspect of the disclosure is to provide a glass article. The glass article comprises: a glass substrate having two surfaces, the two surfaces being substantially parallel to each other and joined by at least one edge; and an outer edge, the outer edge comprising a glass frit disposed on the at least one edge, wherein the glass frit is under compression.

A second aspect of the disclosure is to provide a glass frit material. The glass frit material comprises at least one of at least one of an alkali borosilicate glass, an alkaline earth borosilicate glass, an alkali aluminoborosilicate glass, a tin zinc phosphate glass, a mixed alkali zinc phosphate glass, a lead borate glass, a vanadium phosphate glass, and an antimony vanadium phosphate glass. The glass frit material has a coefficient of thermal expansion in a range from about 40×10⁻⁷/° C. up to about 95×10⁻⁷/° C. and a softening point in a range from about 350° C. up to about 750° C.

A third aspect of the disclosure is to provide a method of making a glass article. The glass article comprises an alkali aluminosilicate glass substrate and an outer edge, the outer edge comprising a glass frit disposed on at least one edge of the substrate. The method comprises the steps of: providing the substrate; providing a glass frit material; disposing the glass frit material on the at least one edge of the substrate; and firing the glass frit material to form the outer edge, the outer edge comprising the glass frit, wherein the glass frit is under compression.

A fourth aspect of the invention is to provide a method of strengthening a glass article having at least one edge. The method comprises the steps of: providing the glass article; providing a glass frit material; disposing the glass frit material on the at least one edge; and firing the glass frit material to form an outer edge of the glass article comprising a glass frit, wherein the glass frit is under compression.

These and other aspects, advantages, and salient features will become apparent from the following detailed description, the accompanying drawings, and the appended claims.

### BRIEF DESCRIPTION OF THE DRAWINGS

FIG. 1a is a schematic cross-sectional view of a glass article having a strengthened outer edge;

FIG. 1b is a schematic cross-sectional view of a glass article that is proud of the bezel of a device;

FIG. 2a is a cross-sectional view of a frit bead on an edge of a glass substrate;

FIG. 2b is a cross-sectional view of a glass substrate having an outer edge comprising a sintered glass frit;

FIG. 2c is a cross-sectional view of a second glass substrate having an outer edge comprising a sintered glass frit;

FIG. 3 is a plot of four-point bend strength as a function of CTE for glass samples edge-coated with glass frit that were not ion exchanged;

FIG. 4 is a second plot of four-point bend strength as a function of CTE for glass samples edge-coated with glass frit that were not ion exchanged; and

FIG. 5 is a plot of four-point bend strength as a function of frit CTE following impact testing for ion exchanged glass samples.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range, as well as any sub-ranges therebewteen.

Referring to the drawings in general, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

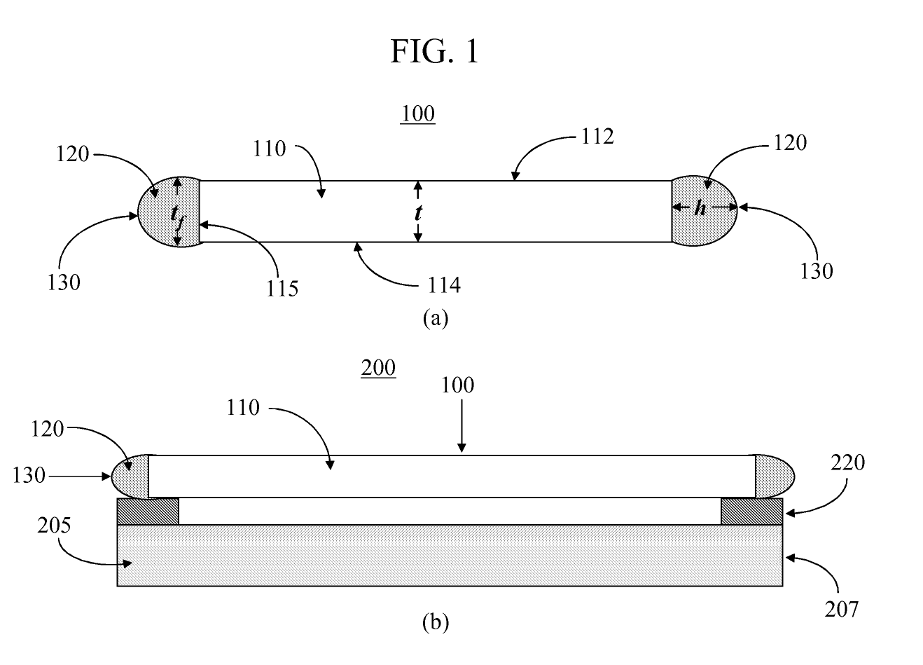

A glass article that can be used as a cover glass, display screen, or touch screen in devices such as, but not limited to, telephones and other communication devices; entertainment devices, such as games, music players and the like; and information terminal (IT) devices, such as laptop computers and the like, is provided and schematically shown in FIG. 1a. Glass article 100 comprises a glass substrate 110 having two surfaces 112, 114, which are joined by at least one edge 115, and a thickness t. In one embodiment, glass substrate 110 has a thickness t in a range from about 0.1 up to about 1.3 mm. A glass fit 120 having a height h is disposed on the at least one edge 115 of glass substrate 110, forming an outer edge 130 of glass article 100. Height h is in a range from about 200 μm up to about 450 μm. Glass fit 120 is under compression. Being under compression, glass frit 120 forces cracks in outer edge 130 to close and thus increases the strength of outer edge 130.

Designs that include cover glasses, display screens, touch screens, or the like are typically limited to a flat piece of glass that is protected by a bezel; i.e., a rim that is used to hold and protect the edge of a glass window or cover plate in a given device. In one embodiment, glass article 100 is a cover glass, display or touch screen, or the like that is free of or “proud of” the bezel of a device—i.e., the edge of the cover glass protrudes above any such bezel or retaining device, and is therefore exposed to the environment. FIG. 1b schematically shows an example of such a glass article 100 that is proud of the bezel 220 and is affixed to body 205 of device 200. Glass article 100, including glass substrate 110, glass frit 120 and outer edge 130, protrudes to the edges of 207 of body 205.

Glass frit 120 provides the additional strengthening that enables glass article 100 to be used in an application in which it is free or proud of a bezel. Glass frit 120 provides glass article 100 with greater impact strength and edge strength than that provided by a ground and polished edge of glass substrate 110, and is substantially free of cracks and particles. There are two different methods to measure edge strength and potential reinforcement. One method is fracture via flexural loading in 3-point or 4-point bend testing on plates having either a rectangular or circular cross-section. The second method is strength loss following impact loading, which simulates dropping of a part onto concrete or other hard surfaces during use. Impact loading is measured, among many other ways, by striking the glass edge at a pre-determined angle with a stainless steel pin, plastic (e.g., polyether ether ketone, or PEEK) pin, or a silicon carbide pin.

Glass frit 120 is, in one embodiment, also thermally and chemically durable, as it is capable of withstanding exposure to salts (e.g., KNO₃, NaNO₃) that are commonly used to strengthen glass substrate 110 by ion exchange at elevated temperatures for prolonged periods of time (e.g., up to about 410° C. for up to about 8 hours). Such ion exchange processes are used to develop desired high strength and scratch resistance in glass substrate 110. In some instances, glass frit 120 is applied and fired at temperatures that are less than the strain point of glass substrate 110 (typically about 550° C.) so as to not relax the compressive stress induced in glass substrate 110 by ion exchange.

Glass frit 120 does not overflow onto surfaces 112, 114 of glass substrate 110; i.e., glass article 100 is, in one embodiment, substantially free of overflow of glass frit 120 onto surfaces 112, 114 of glass substrate 110. The absence of such overflow is necessary to prevent creation of re-entrant angles between the glass frit 115 and substrate 110. Such re-entrant angles generate stress points that can result in crack initiation originating from edge 115 during use. Glass frit 115 has, in some embodiments, a thickness t_{f} that is greater than or equal to thickness t of glass substrate 110, but does not exceed thickness t by more than 2 μm.

Outer edge 130 formed by glass frit 120 provides increased strength to the edge of glass substrate 110. In one embodiment, outer edge 130 has an edge strength before impact loading of at least about 110 MPa. In another embodiment, outer edge 130 has an edge strength without ion exchange of about 10 MPa after impact loading. When strengthened by ion exchange, the edge strength after impact loading is at least about 140 MPa and, in some embodiments, at least about 160 MPa.

Glass frit 120, in some embodiments, comprises, consists essentially of, or consists of at least one of an alkali borosilicate glass, an alkaline earth borosilicate glass, an alkali aluminoborosilicate glass, a tin zinc phosphate glass, a mixed alkali zinc phosphate glass, a lead borate glass, a vanadium phosphate glass, and an antimony vanadium phosphate glass. In some embodiments, glass frit 120 has a softening point (i.e., the temperature at which the glass frit flows and has a viscosity of about 10^{7.6} poise; also referred to as the softening temperature) in a range from about 450° C. up to about 750° C.

In some embodiments, glass frit 120 further comprises up to about 30 wt % of filler material. The filler material, in one embodiment, is or comprises a crystalline material having a coefficient of thermal expansion in a range from about −10×10⁻⁷/° C. up to about 250×10⁻⁷/° C. Non-limiting examples of such filler materials include leucite (16 mol % K₂O, 16.7 mol % Al₂O₃, 66.6 mol % SiO₂) and β-eucryptite (25 mol % Li₂O, 25 mol % Al₂O₃, 50 mol % SiO₂). Non-limiting examples of compositions of glass frit materials and frit blends are listed in Table 1.

TABLE 1
Compositions of glass frit and frit blend materials.

| | A | B | C | D | E |
|---|---|---|---|---|---|
| General | Alkali/alkaline | Low | Zn, alkali | Alkali | Sb, V- |
| description | earth | temperature | borosilicate | alumino- | phosphate |
| | borosilicate | Sb, V- | | borosilicate | with filler |
| | | phosphate | | with filler | |
| Composition | SiO₂, 62.1 | V₂O₅, 57.5 | SiO₂, 69.1 | base glass | base glass |
| (mol %) | B₂O₃, 12.1 | P₂O₅, 25.0 | B₂O₃, 8.6 | (90% wt | (80% wt |
| | Al₂O₃, 5.8 | Sb₂O₃, 17.5 | Al₂O₃, 1.9 | basis) | basis) |
| | Li₂O, 1.1 | Fe₂O₃, 2.5 | Na₂O, 7.0 | SiO₂, 63.9 | V₂O₅, |
| | Na₂O, 8.2 | Al₂O₃, 1.0 | K₂O, 5.2 | B₂O₃, 16.3 | 57.5 |
| | K₂O, 2.7 | TiO₂, 1.0 | ZnO, 5.5 | Al₂O₃, 7.3 | P₂O₅, |
| | MgO, 2.8 | | TiO₂, 2.6 | Li₂O, 3.5 | 25.0 |
| | CaO, 4.6 | | | Na₂O, 3.0 | Sb₂O₃, |
| | ZrO₂, 0.7 | | | K₂O, 6.0 | 17.5 |
| | | | | | Fe₂O₃, 2.5 |
| | | | | | Al₂O₃, |
| | | | | | 1.0 |
| | | | | | TiO₂, |
| | | | | | 1.0 |
| | | | | filler | filler |
| | | | | (10% wt | (20% wt |
| | | | | basis) | basis) |
| | | | | leucite | β- |
| | | | | K₂O, 16.7 | eucryptite |
| | | | | Al₂O₃, 16.7 | Li₂O, |
| | | | | SiO₂, 66.6 | 25.0 |
| | | | | | Al₂O₃, 25.0 |
| | | | | | SiO₂, 50.0 |
| Softening pt | 684° C. | 383° C. | 720° C. | 700° C. (est.) | 425° C. |
| | | | | | (est.) |
| CTE, 10⁻⁷/° C. | 73.8 | 81.8 | 74.8 | 77.8 | 49.0 |
| Expansion | −600 | +75 | −500 | −100 | −70 |
| mismatch, | | | | | |
| ppm | | | | | |
| Firing | 600° C. | 400° C. | 650° C. | 650° C. | 425° C. |
| temperature | | | | | |

In one embodiment, glass frit 120 has a coefficient of thermal expansion (CTE) that is less than or equal to that of glass substrate 110. In one embodiment, glass frit has a coefficient of thermal expansion in a range from about 40×10⁻⁷/° C. up to about 95×10⁻⁷/° C. In another embodiment the CTE of glass frit 120 is in a range from about 49×10⁻⁷/° C. up to about 73×10⁻⁷/° C. In comparison, glass substrate 110, in one embodiment, has a coefficient of thermal expansion in a range from about 40×10⁻⁷/° C. up to about 95×10⁻⁷/° C. and a strain point in a range from about 450° C. up to about 600° C. CTE values for representative glass frit materials are listed in Table 1, as are the CTE or expansion mismatch between the frit material and 2317 glass (66.4 mol % SiO₂; 10.3 mol % Al₂O₃; 0.60 mol % B₂O₃; 4.0 mol % Na₂O; 2.10 mol % K₂O; 5.76 mol % MgO; 0.58 mol % CaO; 0.01 mol % ZrO₂; 0.21 mol % SnO₂; and 0.007 mol % Fe₂O₃) manufactured by Corning Inc., and sold under the name GORILLA GLASS™. The mismatch in CTE between glass substrate 110 and glass frit 120 places glass frit 120—and thus the outer edge 130 of glass article 100—under compression and thus provides glass article 100 with edge strength.

In some embodiments, glass substrate 110 is an alkali aluminosilicate glass. In one embodiment, the alkali aluminosilicate glass substrate comprises, consists essentially of, or consists of: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{Σ alkali metal modifiers ( mol \% )} > 1 ,$$

where the alkali metal modifiers are alkali metal oxides. In another embodiment, the alkali aluminosilicate glass substrate comprises, consists essentially of, or consists of: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In yet another embodiment, the alkali aluminosilicate glass substrate comprises, consists essentially of, or consists of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %. In another embodiment, the alkali aluminosilicate glass substrate comprises, consists essentially of, or consists of: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≦SiO₂+B₂O₃+CaO≦69 mol %; Na₂O+K₂O+B₂O₃+MgO+CaO+SrO>10 mol %; 5 mol % MgO+CaO+SrO≦8 mol %; (Na₂O+B₂O₃)−Al₂O₃≦2 mol %; 2 mol % Na₂O≦Al₂O₃≦6 mol %; and 4 mol %≦(Na₂O+K₂O)−Al₂O₃≦10 mol %. In yet another embodiment, the alkali aluminosilicate glass comprises, consists essentially of, or consists of: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5.

The alkali aluminosilicate glass is, in some embodiments, substantially free of lithium, whereas in other embodiments, the alkali aluminosilicate glass is substantially free of at least one of arsenic, antimony, and barium. In some embodiments, the glass article is down-drawn, using those methods known in the art such as, but not limited to, fusion-drawing, slot-drawing, re-drawing, and the like, and has a liquid viscosity of at least 135 kpoise.

Non-limiting examples of such alkali aluminosilicate glasses are described in U.S. patent application Ser. No. 11/888,213, by Adam J. Ellison et al., entitled “Down-Drawable, Chemically Strengthened Glass for Cover Plate,” filed on Jul. 31, 2007, which claims priority from U.S. Provisional Patent Application 60/930,808, filed on May 22, 2007, and having the same title; U.S. patent application Ser. No. 12/277,573, by Matthew J. Dejneka et al., entitled “Glasses Having Improved Toughness and Scratch Resistance,” filed on Nov. 25, 2008, which claims priority from U.S. Provisional Patent Application 61/004,677, filed on Nov. 29, 2007, and having the same title; U.S. patent application Ser. No. 12/392,577, by Matthew J. Dejneka et al., entitled “Fining Agents for Silicate Glasses,” filed Feb. 25, 2009, which claims priority from U.S. Provisional Patent Application No. 61/067,130, filed Feb. 26, 2008, and having the same title; U.S. patent application Ser. No. 12/393,241 by Matthew J. Dejneka et al., entitled “Ion-Exchanged, Fast Cooled Glasses,” filed Feb. 25, 2009, which claims priority from U.S. Provisional Patent Application No. 61/067,732, filed Feb. 29, 2008, and having the same title; U.S. patent application Ser. No. 12/537,393, by Kristen L. Barefoot et al., entitled “Strengthened Glass Articles and Methods of Making,” filed Aug. 7, 2009, which claims priority from U.S. Provisional Patent Application No. 61/087,324, entitled “Chemically Tempered Cover Glass,” filed Aug. 8, 2008; U.S. Provisional Patent Application No. 61/235,767, by Kristen L. Barefoot et al., entitled “Crack and Scratch Resistant Glass and Enclosures Made Therefrom,” filed Aug. 21, 2009; and U.S. Provisional Patent Application No. 61/235,762, by Matthew J. Dejneka et al., entitled “Zircon Compatible Glasses for Down Draw,” filed Aug. 21, 2009; the contents of which are incorporated herein by reference in their entirety.

In one embodiment, glass substrate 110 is ion exchangeable and can be either thermally or chemically strengthened before or after deposition of glass frit material 120 and/or formation of the glass frit. The strengthened glass substrate 110 or article 100 has strengthened surface layers extending from a first surface 112 and a second surface 114 to a depth of layer below each surface. The strengthened surface layers are under compressive stress, whereas a central region of the glass substrate 100 or article 110 is under tension, or tensile stress, so as to balance forces within the glass. In thermal strengthening (also referred to herein as “thermal tempering”), the glass substrate 100 or article 110 is heated up to a temperature that is greater than the strain point of the alkali aluminosilicate glass but below the softening point of the glass. The glass substrate 110 or article 100 is then rapidly cooled to a temperature below the strain point to create strengthened layers at the surfaces 112, 114 of the glass article 100. In another embodiment, the alkali aluminosilicate glass substrate 110 or article 100 can be strengthened chemically by a process known as ion exchange. In this process, ions in the surface layer of the glass are replaced by—or exchanged with—larger ions having the same valence or oxidation state. In those embodiments in which the glass substrate 110 or article 100 comprises, consists essentially of, or consists of an alkali aluminosilicate glass, ions in the surface layer of the glass and the larger ions are monovalent alkali metal cations, such as Li⁺ (when present in the glass), Na⁺, K⁺, Rb⁺, and Cs⁺. Alternatively, monovalent cations in the surface layer may be replaced with monovalent cations other than alkali metal cations, such as Ag⁺ or the like.

In some embodiments, glass frit 120 is also strengthened by ion exchange. Ion exchange of glass frit 120 can be carried out, using the processes used for the alkali aluminosilicate glass substrate 100 and described herein. Glass frit 120, for example, can be ion exchanged under the same conditions (immersion in a molten salt (100% KNO₃) bath at 410° C. for 8 hours) that are typically used to ion exchange 2317 glass.

Ion exchange processes typically comprise immersing the alkali aluminosilicate glass substrate 110 or article 100 in a molten salt bath containing the larger ions to be exchanged with the smaller ions in the glass. It will be appreciated by those skilled in the art that parameters for the ion exchange process including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass to be achieved by the strengthening operation. By way of example, ion exchange of alkali metal-containing glasses may be achieved by immersion in at least one molten salt bath containing a salt such as, but not limited to, nitrates, sulfates, and chlorides of the larger alkali metal ion. The temperature of the molten salt bath is typically in a range from about 380° C. up to about 450° C., and immersion times range from about 15 minutes up to about 16 hours. However, temperatures and immersion times that are different from those described above can also be used. Such ion exchange treatments typically result in strengthened alkali aluminosilicate glasses having depths of layer ranging from about 10 μm up to at least 50 μm with a surface compressive stress ranging from about 200 MPa up to about 800 MPa, and a central tension of less than about 100 MPa.

Non-limiting examples of ion exchange processes are provided in the U.S. patent applications and provisional patent applications that have been previously referenced hereinabove. Additional non-limiting examples of ion exchange processes in which glass is immersed in multiple ion exchange baths, with washing and/or annealing steps between immersions, are described in U.S. patent application Ser. No. 12/500,650, by Douglas C. Allan et al., entitled “Glass with Compressive Surface for Consumer Applications,” filed Jul. 10, 2009, which claims priority from U.S. Provisional Patent Application No. 61/079,995, filed Jul. 11, 2008, and having the same title, in which glass is strengthened by immersion in multiple, successive, ion exchange treatments in salt baths of different concentrations; and U.S. patent application Ser. No. 12/510,599, by Christopher M. Lee et al., entitled “Dual Stage Ion Exchange for Chemical Strengthening of Glass,” filed Jul. 28, 2009, which claims priority from U.S. Provisional Patent Application No. 61/084,398, filed Jul. 29, 2008, and having the same title, in which glass is strengthened by ion exchange in a first bath that is diluted with an effluent ion, followed by immersion in a second bath having a smaller effluent ion concentration than the first bath. The contents of U.S. Provisional patent application Ser. Nos. 12/500,650 and 12/510,599 are incorporated herein by reference in their entirety.

A method of making the glass article described herein is also provided. A glass substrate 110, such as those described herein, is first provided. The glass substrate can, in some embodiments, be formed by those down-draw methods that are known in the art and also described herein. A glass frit material, such as those described herein, is also provided. The glass frit material can include filler materials, such as those described herein. The frit material and filler (when present) can be sized (e.g. by milling, sizing, and the like) and then applied to at least one edge of the substrate using those means (e.g., dip coating, spray coating, doctor blade, syringe, etc.) known in the art. In one embodiment, the glass frit material is applied as a paste using an automatic dispensing technique. After the frit material is applied to the edge of the glass substrate, the glass substrate 110 and frit material are fired to sinter the glass frit and 120 bond the glass frit 120 to the glass substrate 110, forming the outer edge 130 of the glass article 100. The glass frit 120 forming the outer edge 130 of the glass article 100 is under compression.

In some embodiments, the glass substrate 110 and, in some instances, the glass frit 129, are either thermally or chemically (i.e., by ion exchange) strengthened by those means previously described herein. The glass substrate 110 can be strengthened before application of the glass frit material. In those instances where the glass frit 120 is formed by firing at temperatures that are greater than the strain point of the glass substrate 110, the glass substrate 110 must be strengthened by ion exchange after firing, as firing the frit at the higher temperature would relax the glass substrate 110 and remove the compressive stress induced by ion exchange.

A method of strengthening a glass article having at least one edge is also provided. The first step of the method comprises providing the glass article, which can be an article selected from those articles and glass substrates described herein. A glass frit material, such as those described herein, is also provided. The glass frit material can include filler materials, such as those described herein. The frit material and filler (when present) can be sized (e.g. by milling, sizing, and the like) and then applied to at least one edge of the glass article using those means (e.g., dip coating, spray coating, doctor blade, syringe, etc.) known in the art. In one embodiment, the glass frit material is applied as a paste using an automatic dispensing technique. After the frit material is applied to the edge of the glass article, the glass article and frit material are fired to sinter the frit and bond the frit to the glass article, forming the outer edge of the glass article. The glass frit forming the outer edge of the glass article is under compression and thus strengthens the outer edge of the glass article. The glass article can be further strengthened by chemical (e.g., by ion exchange) or thermal means either before or after application of the outer edge comprising the glass frit, as previously described herein.

### Examples

The following examples illustrate the advantages and features of the present disclosure and are in no way intended to limit the disclosure and the appended claims thereto.

The frit compositions that were selected for study were designed to span a broad CTE range, from well-matched to substantially lower in CTE, relative to the 2317 substrate glass, the composition of which has been previous described herein. Also, frit compositions having relatively low firing temperatures (400°), as well as compositions having much higher firing temperatures (up to 650°) relative to the strain point (550° C.) of the 2317 substrate glass were selected. Table 1 lists compositions and physical properties for the various frits and frit blends that were evaluated for dispensing on the edge of glass substrates.

Composition D, which is a blend of alkali alumino-borosilicate and a filler comprising leucite, was selected in order to evaluate the effect of a near-CTE match with the 2317 glass substrate and high firing temperature on mechanical properties, whereas composition E, which is a blend of antimony vanadium phosphate and β-eucryptite filler, was formulated to provide an extremely high CTE mismatch with the 2317 glass substrate. The value of expansion mismatch for each frit with respect to 2317 glass is also listed in Table 1. This was determined by polarimetric measurement of fired butt seals of the frit and 2317, which is a measure of the residual strain created by the CTE difference between the frit and the 2317 glass (negative expansion values listed in Table 1 denote that the frit is in compression).

Each frit composition was melted in a crucible made of either platinum or silica and then ball milled to an average size of −4 μm/−400 mesh. Frit blends (compositions D and E in Table 1) were made by dry slow rolling the milled frit glass with alumina balls in nalgene bottles, followed by sieving the milled materials through a 325 mesh screen.

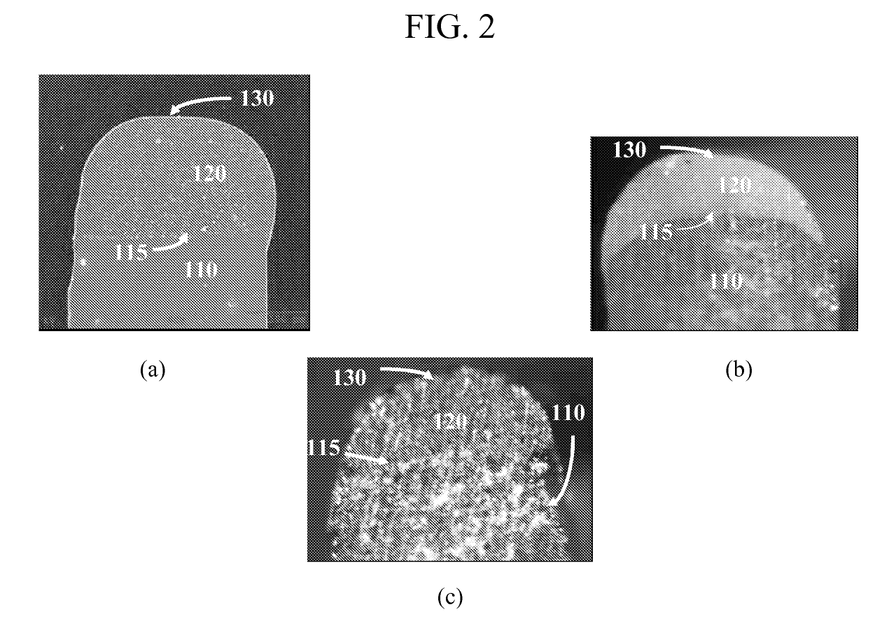

Glass substrates that were edge-coated with frit were prepared by first making a paste of the frit and then applying a bead of the paste to the edges of 2317 glass substrates using an automatic dispensing technique. Other techniques, such as dip coating, spray coating, and the like can be used to apply the frit paste to the edges of the substrate. The parameters (e.g., viscosity) of the frit paste are adjusted to meet the particular requirements of the particular application process. A cross-sectional view of a bead of frit 120 (composition A in Table 1) on the edge 110 of a 2317 glass substrate is shown in FIG. 2a. After the frit paste is applied to the edges of the substrate, the edge-coated substrate is initially fired at a first temperature to burn out organic materials from the frit paste and then fired at a second, higher temperature to sinter the frit material. Substrates that were edge-coated with either composition A or composition D were then fired at 350° C. for about one hour in air, followed by heating at a ramp rate of 2° C./min and firing/sintering at 650° C. in air for two hours. Substrates that were edge-coated with composition B were fired in air for one hour at 325° C., followed by firing/sintering at 400° C. for one hour in a nitrogen atmosphere. Cross-sectional views of glass substrates having outer edges comprising sintered glass frits are shown in FIGS. 2b (composition D) and 2c (composition B).

Thermal mechanical analysis (TMA) results obtained for composition A show that the frit begins to soften around 600° C. and indicate that this particular frit composition must be fired at a temperature above 600° C. in order to form a well-sintered frit on the edge of the 2317 glass substrate, which has a strain point of about 550° C. The high sintering temperature of this frit composition, which is well above the strain point of the 2317 glass substrate, would relax out all of the stress induced by ion exchange. Consequently, the edges of a 2317 glass substrate in this instance would first have to be coated with the frit material and then sintered to form the glass frit and outer edge prior to strengthening the glass substrate by ion exchange.

The mechanical performance of 2317 glass samples that were edge-coated with glass frit was evaluated on the basis of strength, as well as on the basis of impact resistance. Samples were tested as-fired and following ion exchange. From a strength standpoint, the role of the glass frit in strengthening the 2317 substrate edge was assessed by horizontal 4-point bend testing, in which failure origin typically occurs at the edge. The capability of the glass frit in providing damage resistance was measured by determining residual strength in horizontal 4-point bending tests that were performed following impact damage to the frit-coated edge. Impact damage was induced by a device that projects a weight at a controlled velocity onto the edge to be tested. When ion exchanged (IX) samples were tested with a frit applied along the substrate edge, the ion exchange step was performed after the frit firing operation. This is because the 600-650° C. temperature that was used to fire/sinter most of the frits would be sufficient to cause stress relief in the 2317 substrate and would therefore lessen any benefits from the IX step.

Edge-strength results obtained for frits are listed in Table 2. Also shown are data for the 2317 control glass itself—i.e., 2317 glass substrates not having glass frit applied to the edge of the 2317 glass substrate. Strength data are shown for both 2317 samples edge-coated with frit that were fired-only (i.e., no IX treatment), as well as for several of the same combinations of frit material and 2317 glass substrates following frit firing and ion exchange.

TABLE 2
4-point horizontal bend strength results for 2317 samples
edge-coated with glass frit and for 2317 control samples.

| | | 4-pt Horizontal Bend Strength, | |
|---|---|---|---|
| | | Mean ± 1 S.D. (MPa) | |
| Frit | CTE, | | Fired + IX (410°- |
| composition | (10⁻⁷/° C.) | Fired only | 8 hr, 100% KNO₃) |
| E | 49.0 | 87.2 ± 21.4 (n = 6) | (not tested) |
| A | 73.8 | 162.7 ± 30.8 (n = 6) | 245.3 ± 36.5 (n = 5) |
| C | 74.8 | 150.2 ± 20.6 (n = 8) | 231.2 ± 51.7 (n = 8) |
| E | 77.8 | 125.4 ± 16.3 (n = 9) | (not tested) |
| B | 81.8 | 75.4 ± 9.6 (n = 5) | 232.4 ± 30.7 (n = 6) |
| 2317 control | 91.4 | 109.8 ± 22.3 (n = 6) | 672.1 ± 18.6 (n = 15) |
| (no frit on | | | |
| edge) | | | |

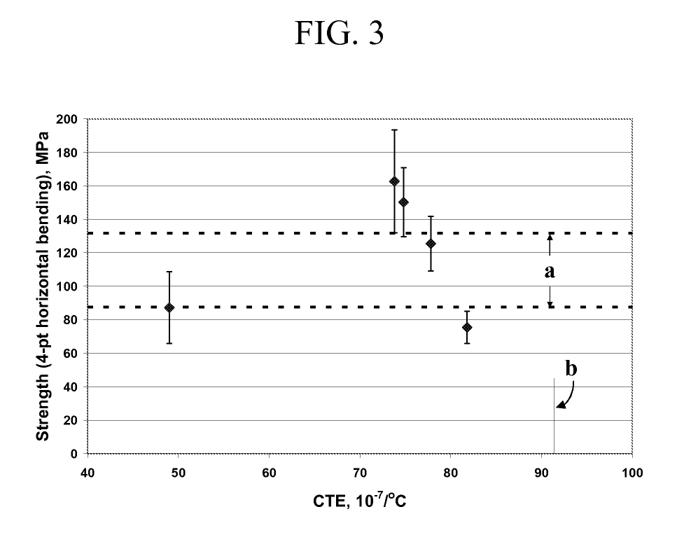

Four-point bend strength data are plotted in FIG. 3 as a function of CTE for all frit-bearing 2317 glass substrates that were not ion exchanged. The CTE of 2317 glass (labeled b in FIG. 3) and the range of bend strengths (a in FIG. 3) measured for 2317 glass substrates having no glass frit deposited on the edges are also included in FIG. 3. With the exception of the fit (composition E) exhibiting the lowest CTE and the highest CTE difference with respect to 2317 glass, a strong inverse correlation was found between frit CTE and strength after frit edge-firing for samples that were not ion exchanged. It is likely that composition E did not exhibit any strengthening because the CTE difference was too great—i.e., cracking to relieve the strain caused by the large CTE difference resulted from the inability of the tensile stresses generated at the surface of the 2317 glass substrate to compensate for the compression in the glass frit. This is also suggested by the anomalous low expansion mismatch of −70 ppm shown in Table 1 for this frit. Based on the trend established by higher CTE fits that were studied, the mismatch for composition E should be in the range from −800 to −1000 ppm, a value that is most likely sufficiently high to initiate cracking. If this is indeed the explanation for the unexpectedly low strength, then the data suggest a lower bound of 49×10⁻⁷/° C. for allowable frit CTE, below which reinforcement no longer occurs.

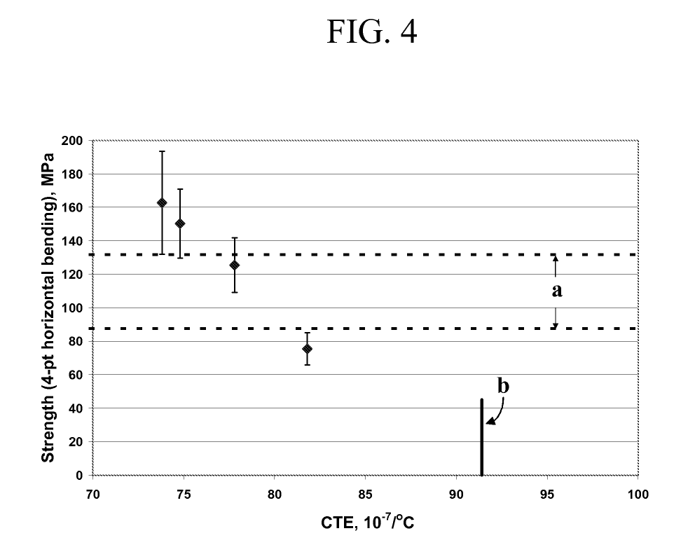

Four-point bend strength data for the frits listed in Table 1 that were not ion exchanged, excluding composition E, are plotted as a function of CTE in FIG. 4. The CTE of 2317 glass (labeled b in FIG. 4) and the range of bend strengths (labeled a in FIG. 4) measured for 2317 glass substrates having no glass frit deposited on the edges are also included in FIG. 4. The role of frit compression in reinforcing the glass edge is demonstrated by the inverse dependence of strength on frit CTE shown in FIG. 4. No similar effect of CTE was found for frit edge-coated 2317 glass samples after ion exchange. Several frit samples exhibited strengths of about 250 MPa following ion exchange, regardless of CTE. These strength values, listed in Table 2, are approximately 35% of that measured on ion exchanged 2317 glass substrates that were not edge-coated with glass frit. The lower edge strength of ion exchanged 2317 glass substrates edge-coated with glass frit compared to the edge strength of ion exchanged 2317 glass substrates without such edge coating reflects the shielding of the 2317 glass edge by the frit from exposure to the ion exchange bath.

Strength values measured using 4-point horizontal bending before and after impact testing are listed in Table 3 for edge-coated samples that were ion exchanged and edge-coated samples that were not ion exchanged. Impact testing was performed at a slide velocity (17.5 in/sec) that was determined to cause substantial damage to the unprotected 2317 glass substrate edge. The presence of the glass frit on the edge of 2317 glass substrates that had not been ion exchanged did not provide any additional damage resistance after impact. For one frit (composition A), however, the presence of a frit-coated edge provided additional damage resistance after impact for ion exchanged 2317 glass substrates. Although all samples (including the ion exchanged 2317 control) suffered a strength loss following impact damage, the mean strength after impact for ion exchanged 2317 substrates edge coated with composition A was nearly 80% higher (294 MPa vs 167 MPa) than that measured for the ion exchanged control 2317 glass substrate.

TABLE 3
Strength results before and after impact loading of 2317 glass
substrates edge-coated with glass frit and 2317 control sample.

| | 4-pt Horizontal Bend Strength, Mean ± 1 S.D. (MPa) | | | |
|---|---|---|---|---|
| | | | IX at 410°-8 hr, | |
| | | | 100% KNO₃ | |
| | Non-IX | | (after frit firing) | |
| | | After impact | | After impact |
| Frit | | @ 17.5 in./ | | @ 17.5 in./ |
| composition | No impact | sec | No impact | sec |
| A | 162.7 ± 30.8 | 0 | 245.3 ± 36.6 | 294.0 ± 31.1 |
| | (n = 6) | | (n = 5) | (n = 5) |
| B | 150.2 ± 20.6 | 0 | 231.2 ± 51.7 | 167.1 ± 86.2 |
| | (n = 6) | | (n = 8) | (n = 6) |
| C | 75.4 ± 9.6 | 0 | 232.4 ± 30.7 | 146.0 ± 91.3 |
| | (n = 6) | | (n = 6) | (n = 5) |
| 2317 (no frit) | 109.8 ± 22.3 | 9.8 ± 4.1 | 672.1 ± 18.6 | 167.0 ± 25.6 |
| | (n = 6) | (n = 5) | (n = 15) | (n = 4) |

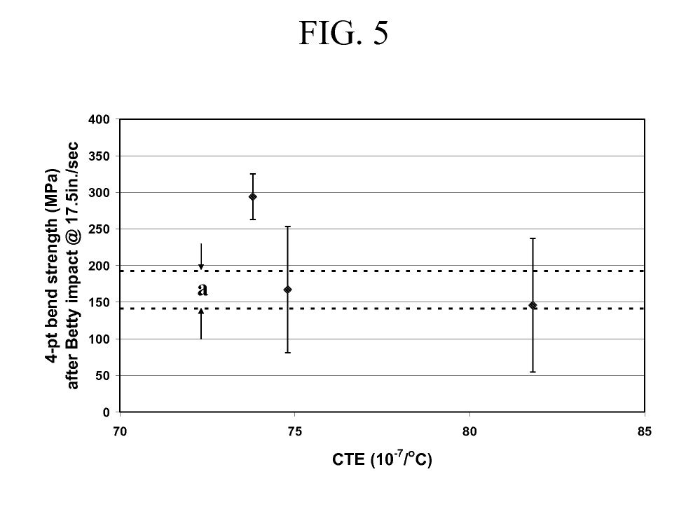

Four-point bend strength following damage from the impacter for edge-coated ion exchanged 2317 glass substrates that were edge-coated with glass frit is plotted as a function of frit CTE in FIG. 5, with a denoting the range of bend strengths measured for ion-exchanged 2317 glass substrates having no glass frit deposited on the edges. No effect from frit CTE is observed. As noted, composition A was the single frit material that provided damage resistance. This frit material was also among the two frit materials in FIG. 5 that provided the highest edge strengthening.

As previously described herein, composition A is a mixed alkali/mixed alkaline earth borosilicate glass containing 8 mol % Na₂O. The improvement in the damage resistance of 2317 glass substrates can be attributed to strengthening of the frit itself by ion exchange (the standard ion exchange treatment for 2317 glass substrates comprises immersion in a 100% KNO₃ bath at 410° C. bath for 8 hours). This is further supported by the fact that none of the frits evaluated, including composition A, provided any measure of damage resistance for 2317 glass substrates that had not been ion exchanged.

To determine the strength of the frit alone, ring-on-ring strength measurements were performed on samples of frit on polished disks after firing, but not ion exchanged, and after firing followed by ion exchange. Results of these measurements are listed in Table 4. The results of these measurements show that the strength of composition A frits doubled when ion exchanged.

TABLE 4
Ring-on-ring strength data for frits only.

| | | Ring-on-Ring | Number of |
|---|---|---|---|
| Frit | Treatment prior to | strength results | samples in |
| composition | testing | (MPa) | each data set |
| A | 2 hr @ 650° C. | 60 ± 15 | 12 |
| A | 2 hr @ 650° C.; | 120 ± 37 | 10 |
| | IX* (8 hr @ 410° C. in | | |
| | KNO₃) | | |
| A | 2 hr @ 650° C.; | 123 ± 35 | 12 |
| | IX (8 hr @ 410° C. in | | |
| | 60% KNO₃/40% NaNO₃) | | |
| A | 2 hr @ 650° C.; | 161 ± 58 | 12 |
| | IX (8 hr @ 410° C. in | | |
| | KNO₃) | | |
| D | 2 hr @ 650° C. | 37 ± 4 | 9 |
| C | 2 hr @ 650° C.; | 66 + 8 | 9 |
| | IX (8 hr @ 410° C. in | | |
| | KNO₃) | | |

*ion exchanged

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass article, the glass article comprising:
a. a glass substrate, the glass substrate having two surfaces, the two surfaces being substantially parallel to each other and joined by at least one edge; and
b. an outer edge, the outer edge comprising a glass frit disposed on the at least one edge, wherein the glass frit is under compression.

2. The glass article of claim 1, wherein the glass article is free of overflow of the glass frit onto the two surfaces.

3. The glass article of claim 2, wherein the glass substrate has a first thickness and the glass frit has a second thickness, the second thickness being greater than or equal to the first thickness and exceeding the first thickness by less than 2 μm.

4. The glass article of claim 1, wherein the glass frit has a coefficient of thermal expansion in a range from about 40×10⁻⁷/° C. up to about 95×10⁻⁷/° C.

5. The glass article of claim 1, wherein the glass frit has a softening point in a range from about 350° C. up to about 750° C.

6. The glass article of claim 1, wherein the outer edge of the glass article has an edge strength of at least about 110 MPa.

7. The glass article of claim 1, wherein the outer edge of the glass article has an edge strength after impact loading of greater than about 10 MPa.

8. The glass article of claim 1, wherein at least one of the glass substrate and glass frit is ion exchangeable.

9. The glass article of claim 1, wherein the glass article is strengthened by one of thermal strengthening and chemical strengthening.

10. The glass article of claim 9, wherein at least one of the glass substrate and glass frit is chemically strengthened by ion exchange.

11. The glass article of claim 1, wherein the glass substrate has a coefficient of thermal expansion in a range from about 40×10⁻⁷/° C. up to about 95×10⁻⁷/° C. and a strain point in a range from about 450° C. up to about 600° C.

12. The glass article of claim 11, wherein the glass substrate is an alkali aluminosilicate glass.

13. The glass article of claim 12, wherein the alkali aluminosilicate glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

14. The glass article of claim 12, wherein the alkali aluminosilicate glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

15. The glass article of claim 12, wherein the alkali aluminosilicate glass comprises: 60-72 mol % SiO₂; 9-16 mol % Al₂O₃; 5-12 mol % B₂O₃; 8-16 mol % Na₂O; and 0-4 mol % K₂O, wherein the ratio
$$\frac{{Al}_{2} {O}_{3} ( mol \% ) + {B}_{2} {O}_{3} ( mol \% )}{Σ alkali metal modifiers ( mol \% )} > 1.$$

16. The glass article of claim 12, wherein the alkali aluminosilicate glass has a liquidus viscosity of at least about 135 kpoise.

17. The glass article of claim 12, wherein the alkali aluminosilicate glass is lithium-free.

18. The glass article of claim 12, wherein the alkali aluminosilicate glass is down-drawable.

19. The glass article of claim 12, wherein the glass frit has a coefficient of thermal expansion that is less than or equal to a coefficient of thermal expansion of the alkali aluminosilicate glass.

20. The glass article of claim 1, wherein the glass substrate has a thickness in a range from about 0.1 up to about 1.3 mm.

21. The glass article of claim 1, wherein the glass frit comprises at least one of an alkali borosilicate glass, an alkaline earth borosilicate glass, an alkali aluminoborosilicate glass, a tin zinc phosphate glass, a mixed alkali zinc phosphate glass, a lead borate glass, a vanadium phosphate glass, and an antimony vanadium phosphate glass.

22. The glass article of claim 1, wherein the glass frit further comprises a filler material.

23. The glass article of claim 22, wherein the filler material comprises a crystalline material having a coefficient of thermal expansion in a range from about −10×10⁻⁷/° C. up to about 250×10⁻⁷/° C.

24. The glass article of claim 1, wherein the glass article forms at least a portion of one of an enclosure or a window for an electronic device, and wherein the glass article is disposed adjacent to a bezel, and wherein the glass article is proud of the bezel.

25. A glass frit material, the glass frit material comprising at least one of at least one of an alkali borosilicate glass, an alkaline earth borosilicate glass, an alkali aluminoborosilicate glass, a tin zinc phosphate glass, a mixed alkali zinc phosphate glass, a lead borate glass, a vanadium phosphate glass, and an antimony vanadium phosphate glass, wherein the glass frit material has a coefficient of thermal expansion in a range from about 40×10⁻⁷/° C. up to about 95×10⁻⁷/° C. and a softening point in a range from about 350° C. up to about 750° C.

26. The frit material of claim 25, wherein the frit material, when disposed on a surface of an alkali aluminosilicate glass and sintered, is under compression.

27. A method of making a glass article, the glass article comprising an alkali aluminosilicate glass substrate and an outer edge, the outer edge comprising a glass frit disposed on at least one edge of the substrate, the method comprising the steps of:
a. providing the substrate, the substrate having a thickness;
b. providing a glass frit material;
c. disposing the glass frit material on the at least one edge of the substrate; and
d. firing the glass frit material to form the outer edge, the outer edge comprising the glass frit, wherein the glass frit is under compression.

28. The method of claim 27, wherein the glass frit has a thickness that is less than 2 μm greater than the thickness of the substrate.

29. The method of claim 27, wherein the step of providing the substrate further comprises strengthening the substrate.

30. The method of claim 29, wherein the step of strengthening the substrate comprises ion exchanging the substrate.

31. The method of claim 27, further comprising the step of ion exchanging the glass article after firing the glass frit material to form the outer edge.

32. A method of strengthening a glass article having at least one edge, the method comprising the steps of:
a. providing the glass article;
b. providing a glass frit material;
c. disposing the glass frit material on the at least one edge; and
d. firing the glass frit material to form an outer edge of the glass article comprising glass frit, wherein the glass frit is under compression.

33. The method of claim 32, wherein the step of providing the substrate further comprises strengthening the substrate.

34. The method of claim 33, wherein the step of strengthening the substrate comprises ion exchanging the substrate.

35. The method of claim 32, further comprising the step of ion exchanging the glass article after firing the glass frit material to form the outer edge, and wherein the glass frit is strengthened by ion exchange.

36. The method of claim 32, wherein the glass substrate has a first thickness and the glass frit has a second thickness, the second thickness being greater than or equal to the first thickness and exceeding the first thickness by less than 2 μm.
